(19) United States
(12) Patent Application Publication
(10) Pub. No.: US 2019/0346140 A1
(43) Pub. Date: Nov. 14, 2019

(54) Burner Tip Comprising an Air Passage System and a Fuel Passage System for a Burner

(71) Applicant: Siemens Aktiengesellschaft, München (DE)

(72) Inventors: Christoph Kiener, München (DE); Andreas Kreutzer, Berlin - Hellersdorf (DE); Carl Hockley, Worcester (GB); Matthias Salcher, München (DE)

(73) Assignee: Siemens Aktiengesellschaft, München (DE)

(21) Appl. No.: 16/475,790

(22) PCT Filed: Jan. 2, 2018
(86) PCT No.: PCT/EP2018/050015

§ 371 Date: Jul. 3, 2019

(30) Foreign Application Priority Data
Jan. 5, 2017 (DE) 10 2017 200 106.2

(51) Int. Cl. F23R 3/28; F23D 11/38; F23D 14/22; F23D 14/78

(52) U.S. Cl. CPC F23R 3/283; F23D 11/38; F05D 2260/232; F23D 14/78; F23D 14/22

(57) ABSTRACT

Various embodiments include a burner tip for installing in a burner comprising: an air passage system open to the surrounding area of the burner tip; a fuel passage system open to the surrounding area of the burner tip; an inner wall and an outer wall; an annulus between the inner wall and the outer wall; and heat-conducting structures projecting into the annulus from the outer wall connecting the outer wall and the inner wall. The annulus forms a part of the air passage system. The heat-conducting structures include connecting ribs. Connecting passages extend through the connecting ribs, open on one end into the annulus and on another end through the outer wall.

### CROSS-REFERENCE TO RELATED APPLICATIONS

This application is a U.S. National Stage Application of International Application No. PCT/EP2018/050015 filed Jan. 2, 2018, which designates the United States of America, and claims priority to DE Application No. 10 2017 200 106.2 filed Jan. 5, 2017, the contents of which are hereby incorporated by reference in their entirety.

### TECHNICAL FIELD

The present disclosure relates to burners. Various embodiments include burner tips for installing in a burner, burners, and/or methods for the manufacture of burner tips and/or burners.

### BACKGROUND

Burner tips are described, for example, in EP 2 196 733 A1. The burner tip described there can be used in a gas turbine, wherein the burner tip forms the downstream disposed end of a burner lance which is arranged in a main passage for combustion air. The burner tip is of double-wall construction, wherein the outer wall forms a heat shield which is intended to keep resulting combustion heat away from the inner wall. Therefore, an annular chamber, in other words an annulus, through which air can flow via openings for cooling purposes, is arranged between the outer wall and the inner wall. In the case of the described embodiment, the heat shield has to be designed for tolerating the thermal stress on account of the combustion which takes place in the downstream combustion chamber. Therefore, the outer wall of the burner tip represents the limiting factor for the service life of the burner tip.

### SUMMARY

The present disclosure describes various burner tips wherein the burner tip has an air passage system, which is open to the surrounding area of the burner tip, and a fuel passage system, which is open to the surrounding area of the burner tip. In this case, the burner tip is of double-wall construction with an inner wall and an outer wall and an annulus which lies there between, wherein the annulus forms a part of the air passage system, i.e. the air passage system leads through the annulus before it opens to the surrounding area of the burner tip. In this way, the burner tip has openings on its surface which create a connection of the air passage system and the fuel passage system to the surrounding area of the burner tip. The surrounding area of the burner tip is formed in this case for example by means of a combustion chamber in which fuel which is delivered by means of the fuel passage system is combusted. This combustion chamber can be arranged for example in a gas turbine. The present disclosure describes burner tips of this type with an improvement of the service life of the component.

Some embodiments include a burner tip for installing in a burner (11), wherein the burner tip has an air passage system which is open to the surrounding area of the burner tip and a fuel passage system which is open to the surrounding area of the burner tip, wherein the burner tip is of double-wall construction with an inner wall (29) and an outer wall (28) and an annulus (26) which lies there between and wherein the annulus (26) forms a part of the air passage system, wherein heat-conducting structures (27), which project into the annulus (26), are attached on the outer wall (28), characterized in that the heat-conducting structures (27) interconnect the outer wall (28) and the inner wall (29) and consist of pillar-like connecting ribs, wherein connecting passages (32) extend in the interior of the connecting ribs, open by their one end into the annulus (26) and by their other end pass through the outer wall (28).

In some embodiments, the heat-conducting structures (27) are constructed in one piece with the inner wall (29) and the outer wall (28).

In some embodiments, the outer wall (28) is provided with openings (31).

In some embodiments, at least a part of the outer wall (28) is of funnel-shaped design.

In some embodiments, at least a part of the inner wall (29) which lies opposite the outer wall (28) is also of funnel-shaped design.

In some embodiments, the heat-conducting structures (27), which are constructed as pillar-like ribs, are oriented perpendicularly to the outer wall (28) at their connecting point to this.

In some embodiments, the heat-conducting structures are arranged in the annulus (26) in concentric circles (35).

In some embodiments, a central air passage (20), which is part of the air passages structure, extends in the burner tip and this central air passage (20) is connected via openings (25) to the annulus (26).

In some embodiments, the central air passage (20) leads to a central discharge orifice (24) in the burner tip.

In some embodiments, a multiplicity of fuel passages (33), which are part of the fuel passage system, lead through the annulus (26) and are connected to fuel orifices (34) in the outer wall.

In some embodiments, the fuel passages (33) are in communication with an annular passage (22) which encompasses the central air passage (20) and is part of the fuel passage system.

Some embodiments include a method for producing a burner tip which is constructed as described above, characterized in that an additive manufacturing process is used for the production, in which the outer wall (28), the heat-conducting structures (27) and the inner wall (29) are produced in one piece.

Some embodiments include a burner tip of double-wall construction with an inner wall (29) and an outer wall (28) and an annulus (26) which lies there between, and with heat-conducting structures (27) which interconnect the outer wall (28) and the inner wall (29), which burner tip is produced as described above.

### BRIEF DESCRIPTION OF THE DRAWINGS

Further details of the teachings herein are described below with reference to the drawings. The same or corresponding drawing elements are explained more than once only if there are differences between the individual figures. In the drawings:

FIG. 1 shows the schematic construction of a burner, installed in which is an exemplary embodiment of a burner tip incorporating teachings of the present disclosure, in section,

FIG. 2 shows an exemplary embodiment of a burner tip incorporating teachings of the present disclosure in section,

FIG. 3 shows the detail III-III according to FIG. 2,

FIG. 4 shows another exemplary embodiment of a burner tip incorporating teachings of the present disclosure in section, and

FIG. 5 shows an exemplary embodiment of a method incorporating teachings of the present disclosure as a detail.

### DETAILED DESCRIPTION

In some embodiments, heat-conducting structures are attached on the outer wall of a burner tip, which heat-conducting structures project into the annulus. These heat-conducting structures therefore enlarge the surface of the outer wall (on the side of the annulus) which is provided for a transfer of heat compared with a smooth surface. In relation to this disclosure, the structure which separates the annulus from the surrounding area of the burner tip is to be referred to as outer wall. This has an outwardly and an inwardly directed wall surface respectively. Similarly, the structure which separates the annulus from the inner structures of the burner tip (for example a central air passage) is understood as inner wall. The inner wall also provides a wall surface which points toward the annulus, and a wall surface which lies opposite this wall surface.

The heat-conducting structures can be geometrically different in design providing their shape in comparison to a smooth wall surface of the outer wall in the annulus leads to a surface enlargement. The surface enlargement enables a faster transfer of heat from the outer wall into the annulus where this heat can be absorbed by the flowing air. As a result of this, an improved cooling effect, which leads to lower thermal loading of the outer wall, can be achieved. As a result, it is possible to reduce the thermal loads of the outer wall and therefore to extend the service life of the burner tip.

In some embodiments, the heat-conducting structures have a geometry which connects the outer wall and the inner wall. As a result, it is possible to enlarge the surface for a transfer of heat since the heat can also be directed via the heat-conducting structures from the outer wall into the inner wall. The inner wall can release the heat to the air via the wall surface which delimits the annulus. Also, heat dissipation into the rest of the burner tip is possible, wherein this is consequently heated more uniformly. In this way, thermal stresses between the inner and the outer wall can be reduced, which in addition contributes to an extension of the service life.

In some embodiments, the heat-conducting structures are constructed in one piece with the inner wall and the outer wall. As a result of this, it is possible to improve the conduction of heat between the heat-conducting structures and the inner wall so that the already described effect of thermal unloading of the outer wall is further increased. Furthermore, a mechanically particularly stable connection between outer wall and inner wall results in this way.

The production can be carried out for example by means of casting with a lost core. In some embodiments, an additive manufacturing process is used for the production. With this, the outer wall, the heat-conducting structures and the inner wall can be produced in one piece, wherein additive manufacturing also enables geometrically complex constructions with an large surface for transfer of heat. As additive manufacturing processes, processes in which the material from which a component is to be produced is added to the component during the development, are to be understood in the sense of this disclosure. In some embodiments, the component is already developed in its final form or developed at least approximately in this form. In some embodiments, the construction material is in powder form, wherein as a result of the additive manufacturing process the material for producing the component is physically solidified, with the introduction of energy.

In some methods to produce a burner tip incorporating the teachings herein, data describing the component (CAD model) is prepared for the selected additive manufacturing process. For establishing instructions for the manufacturing plant, the data is converted into data of the component which is adapted to the manufacturing process so that the suitable process steps for successive production of the component can proceed in the manufacturing plant. The data is prepared for this so that the geometric data for the layers (slices) of the component which are to be produced in each case is made available, which is also referred to as slicing.

Examples for the additive manufacturing include selective laser sintering (SLS), selective laser melting (SLM), electron beam melting (EBM), laser metal deposition (LMD), and/or cold gas dynamic spraying (GDCS). These processes are especially suitable for the processing of metallic materials in the form of powders with which construction components can be produced.

In the case of SLM, SLS and EBM, the components are produced in layers in a powder bed. These processes are therefore also referred to as powder bed-based additive manufacturing processes. A layer of the powder is created in the powder bed in each case and by means of the energy source (laser or electron beam) is then locally melted or sintered in those regions in which the component is to be developed. In this way, the component is produced successively in layers and can be removed from the powder bed after completion.

In the case of LMD and GDCS, the powder particles are fed directly to the surface on which material deposition is to be carried out. In the case of LMD, the powder particles are melted by means of a laser directly on the surface at the impingement point and in the process form a layer of the component which is to be created. In the case of GDCS, the powder particles are highly accelerated so that primarily on account of their kinetic energy they remain adhered on the surface of the component with simultaneous deformation.

GDCS and SLS have in common the feature that the powder particles are not completely melted in the case of these processes. This also enables inter alia the production of porous structures if spaces are retained between the particles. In the case of GDCS, melting is carried out at most in the edge region of the powder particles which can melt on its surface on account of the high degree of deformation. When selecting the sintering temperature in the case of SLS, consideration is given to the fact that this lies below the melting temperature of the powder particles. In contrast to this, in the case of SLM, EBM and LMD the energy input with respect to value lies deliberately high so that the powder particles are completely melted.

For the geometric design of the heat-conducting structures availability is made of a multiplicity of geometric shapes which are suitable for enlarging the wall surface of the outer wall which is directed toward the annulus. For example, fins or knobs or pillar-like connecting ribs may connect the outer wall and the inner wall. These connecting ribs in cross section can be of round, oval or even cornered design. The cross section can also be of variable design in its progression from the outer wall to the inner wall. Pillar-like connecting ribs may form a type of gallery in the annulus, which on the one hand ensures a high degree of mechanical stability and on the other hand ensures a large surface for a transfer of heat to the air which is conducted in the air passage system.

In some embodiments, connecting passages extend inside the connecting ribs and by their one end open into the annulus and by their other end pass through the outer wall. Created as a result of this is an additional connection for the air so that the connecting passages are also to be understood as being part of the air passage system. The air is therefore conducted via a multiplicity of connecting passages toward the surface of the burner tip which is formed by the outer surface of the outer wall and forms there a protective air jacket around the burner tip. Admittedly, the air, after discharging from the connecting passages, is already heated as a result of the absorption of heat of the outer wall, but the temperature level in the surrounding area of the burner tip is higher during the combustion process so that an additional cooling effect can be achieved by means of the air jacket. In some embodiments, this effect can also be achieved if the outer wall is provided with openings which connect the annulus directly to the surrounding area of the burner tip and therefore are also to be understood as being part of the air passage system. The passages can also be used in common with the already mentioned connecting passages.

In some embodiments, at least a part of the outer wall is of funnel-shaped design. In particular, a conical design is possible, but curved wall progressions, which taper toward the burner tip, are also conceivable. Particularly if connecting passages or openings are provided in the outer wall for the air, the outflowing air is distributed in a flow-conducive manner in the case of a funnel-shaped, especially conical, outer contour of the burner tip in order to form a protective air jacket in the direct surrounding area of the burner tip.

In some embodiments, at least a part of the inner wall which lies opposite the outer wall is also of funnel-shaped, especially conical, design. In such embodiments, the annulus which lies between inner wall and outer wall enables a uniform throughflow with air and in particular the pillar-like connecting ribs also have in the main the same length and therefore have a comparable thermal behavior. In this way, the entire burner tip can be heated comparatively uniformly.

The heat-conducting structures, constructed as connecting ribs, can be oriented perpendicularly to the outer wall at their connecting point to this. As a result of this, a connection between the outer wall and the inner wall which is as short as possible can be created in order to also introduce some of the heat into the inner wall. Furthermore, the heat-conducting structures can be arranged in the annulus in concentric circles, wherein this assumes that the annulus provides sufficient installation space in the radial direction. As a result of the referenced arrangement, a uniform throughflow by the air can be created in the annulus, the path of the throughflow being in particular oriented centrally symmetrically.

In some embodiments, a central air passage, which is part of the air passage structure, extends in the burner tip and this central air passage is connected via openings to the annulus. In this way, the air from the central air passage is introduced into the annulus via the openings which are also part of the air passage structure, wherein the openings can also be distributed uniformly on the circumference in order to ensure a uniform flow of air through the annulus.

In some embodiments, the central air passage leads to a central discharge orifice in the burner tip. In this passage, a further lance with a nozzle can be arranged in a way that an air gap remains between the lance and the air passage and also the central discharge orifice so that an airflow can be formed in the air gap.

This airflow effects an additional thermal protection of the burner tip and the lance since the air which flows through the central discharge orifice is cooler than the combustion temperatures which prevail in the combustion chamber surrounding the burner tip.

In some embodiments, a multiplicity of fuel passages, which are part of the fuel passage system, lead through the annulus, wherein these fuel passages are connected to fuel orifices in the outer wall. These fuel orifices can be uniformly distributed on the circumference of the burner tip so that the fuel is introduced uniformly into the flowing air and distributed in this. The thermal loading of the burner tip is also homogenously eliminated as a result of the subsequent more uniform combustion of the fuel, as a result of which asymmetric thermal load spikes are avoided.

In some embodiments, the fuel passages are in communication with an annular passage which encompasses the central air passage and is also part of the fuel passage system. In this way, the fuel can be fed uniformly to all the fuel passages, therefore the amount of fuel released to the various fuel orifices is also homogenous. Such embodiments may provide a uniform combustion of the fuel and a uniform thermal loading of the burner tip.

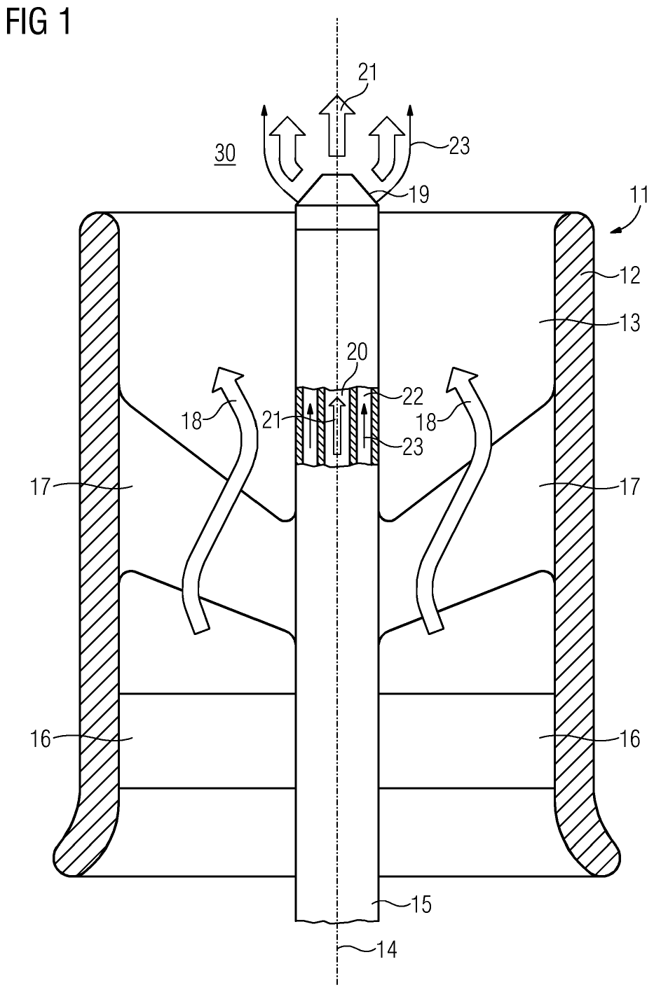

FIG. 1 shows a burner 11 which has a shell 12 in which is formed a main passage 13 for air. The shell 13 is constructed symmetrically around a symmetry axis 14 and has a burner lance 15 in the center of the main passage 13. The burner lance 15 is fixed in the main passage 13 by ribs 16. Also, guide vanes 17, which impose a swirl upon the air around the symmetry axis 14, as is to be gathered from the indicated air arrows 18, extend between the burner lance 15 and the shell 12.

The burner lance 15 has a burner tip 19 at the downstream end, wherein this is supplied with air 21 via a central air passage 20 and with a fuel 23 via an annular passage 22 which is arranged around the air passage 20. The fuel 23 can be gaseous or liquid. The air 21 and the fuel 23 are expelled via openings, not shown in more detail, in the burner tip and are therefore added to the airflow from the main passage 13. In the process, the air 21 cools the burner tip 19 (more on this matter in the following text). The burner 11 follows the functioning principle of a pilot burner. This can be installed for example in a combustion chamber, not shown in more detail, of a gas turbine, wherein the combustion chamber in this case forms a surrounding area 30 of the burner tip. A fuel lance (not shown) can also be arranged in the air passage 21 for the injection of a different fuel, by means of which the air is displaced toward the outlet in the conical outer surface.

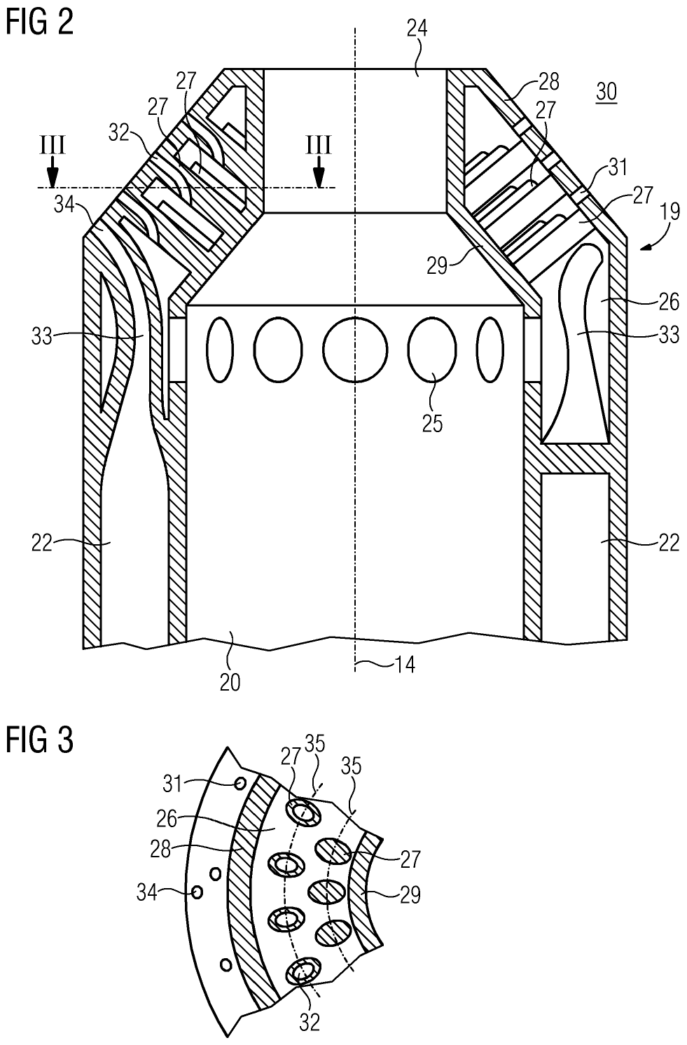

FIG. 2 shows the burner tip 19 in section. To be seen here is the central air passage 20 which extends along the symmetry axis 14 and leads to a discharge orifice 24 on the burner tip. The air passage 20 also has openings 25 in the sidewall which connect the air passage 20 to an annulus 26 which encompasses the air passage in a ring-like manner. In this way, air also makes its way into the annulus which is part of the air passage structure formed in the burner tip 19. In the annulus, the air flows around heat-conducting structures 27, wherein the heat-conducting structures are designed as pillar-like ribs which connect an outer wall 28 of the annulus to an inner wall 29 of the annulus 26. The outer wall 28 delimits the annulus 26 toward the surrounding area 30 of the burner tip 19 and the inner wall 29 delimits the annulus 26 toward the central air passage 20. The openings 25 are therefore located in the inner wall 29.

So that the air can escape from the annulus 26 into the surrounding area 30, openings 31 are provided in the outer wall 28. In their interior, the heat-conducting structures 27 can also have connecting passages 32 with an opening through which air can enter the interior of the annulus and can be directed in the heat-conducting structures toward the surrounding area 30 of the burner tip 19. As a result of this, an additional surface enlargement is achieved so that the heat from the heat-conducting structures 27 can be released to the air as quickly as possible. As a result of the multiplicity of openings and connecting passages on the outer surface, a cooling air jacket is created on the outer wall 28 which decelerates the transfer of combustion heat from the surrounding 30. In order to aid the forming of this air jacket, the outer wall 28 is designed in the shape of a cone. The inner wall 29 also forms a cone so that the annulus 26 has a constant height in this region. The heat-conducting structures 27 in the form of pillar-like ribs therefore form a conical gallery, wherein the ribs are perpendicular to the outer wall 28 and to the inner wall 29. The pillars which lie behind the plane of the drawing are also indicated in FIG. 2.

The annular passage 22 opens into a plurality of fuel passages 33 which are distributed on the circumference. These conduct the liquid or gaseous fuel to fuel orifices 34 which are also arranged in the conical region of the outer wall 28. In the case of the view according to FIG. 2, provision is made for an odd number of fuel passages 33 so that these are only shown in section on one side. Otherwise, this also applies to the heat-conducting structures 27.

It can be gathered from FIG. 3 that the heat-conducting structures 27 in the annulus 26 are arranged on imaginary concentric circles 35. As a result of this, a flow-conducive arrangement is created. Unlike the view in FIG. 2, the heat-conducting structures 27 according to FIG. 3 are arranged on the concentric circles 35 in a staggered manner. As a result of this, the air in the annulus is forced into a direction change more frequently and as a result can absorb more heat from the heat-conducting structures 27.

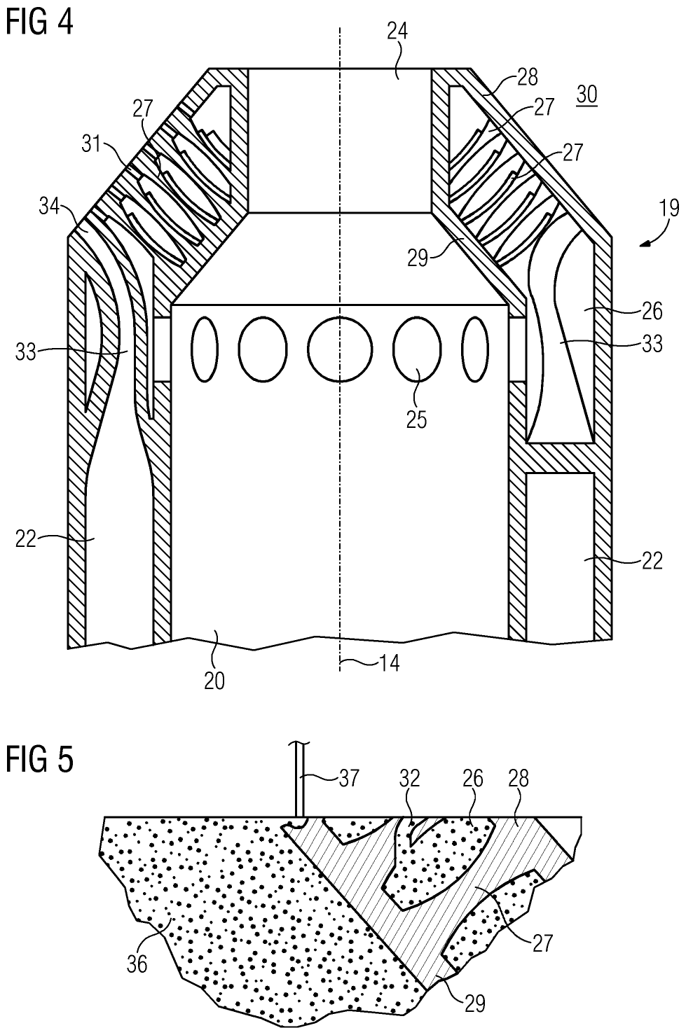

The burner tip 19 according to FIG. 4 is constructed in a similar way to the burner tip 19 according to FIG. 2. Only the differences shall be explained in the following text. The heat-conducting structures 27 are also constructed as pillar-like ribs, which connect the outer wall 28 to the inner wall 29 and are produced in one piece with these. However, the heat-conducting structures 27 are of a more slender design and do not have any connecting passages. For this, provision is made for a larger number of openings 31 in the outer wall, as a result of which the forming of a closed air jacket on the outside at the burner tip 19 is aided.

The connecting structures are otherwise denser than in FIG. 2 and do not have a constant cross-sections. In the progression from the outer wall 28 to the inner wall 29, the heat-conducting structures taper in their cross section toward the middle of the annulus 26 and then widen out again in the direction toward the inner wall 29. As a result of the cross-sectional tapering, the conducting of heat from the outer wall 28 to the inner wall 29 can be influenced. Moreover, as a result of the tapering sufficient volumes can be made available for the flowing air even in the case of a large number of heat-conducting structures.

FIG. 5 shows in detail how a component according to FIG. 2 or FIG. 4 can be produced by means of laser melting using a laser beam 37. Shown is the detail of a powder bed 36 in which just a part of the outer wall 28, the inner wall 29 and the heat-conducting structures 27 is produced. The heat-conducting structures 27 are constructed as pillar-like ribs with a cross-sectional shape according to FIG. 4, wherein connecting passages 32 according to FIG. 2 are also produced. After production of the finished structure, the powder has to be removed from the cavities, formed in the annulus 26, which form the air passage system. This can be carried out by sucking, shaking, or blowing out.

What is claimed is:

1. A burner tip for installing in a burner, the burner tip comprising:
an air passage system open to the surrounding area of the burner tip;
a fuel passage system open to the surrounding area of the burner tip;
an inner wall and an outer wall;
an annulus between the inner wall and the outer wall;
wherein the annulus forms a part of the air passage system; and
heat-conducting structures projecting into the annulus from the outer wall connecting the outer wall and the inner wall;
wherein the heat-conducting structures include connecting ribs;
connecting passages extend through the connecting ribs, open on one end into the annulus and on another end through the outer wall.

2. The burner tip as claimed in claim 1, wherein the heat-conducting structures are constructed in one piece with both the inner wall and the outer wall.

3. The burner tip as claimed in claim 1, wherein the outer wall includes openings.

4. The burner tip as claimed in claim 1, wherein at least a part of the outer wall comprises a funnel shaped.

5. The burner tip as claimed in claim 4, wherein at least a part of the inner wall opposite the outer wall comprises a funnel shaped.

6. The burner tip as claimed in claim 3, wherein the heat-conducting structures comprise ribs oriented perpendicularly to the outer wall at respective connecting points.

7. The burner tip as claimed in claim 6, wherein the heat-conducting structures are disposed in the annulus in concentric circles.

8. The burner tip as claimed in claim 1, further comprising a central air passage extending through the burner tip and connected via openings to the annulus.

9. The burner tip as claimed in claim 8, wherein the central air passage connects to a central discharge orifice in the burner tip.

10. The burner tip as claimed in claim 9, further comprising a multiplicity of fuel passages leading through the annulus and connected to fuel orifices in the outer wall.

11. The burner tip as claimed in claim 10, wherein the fuel passages communicate with an annular passage which encompasses the central air passage and is part of the fuel passage system.

12. A method for producing a burner tip, the method comprising:
defining an air passage system open to the surrounding area of the burner tip;
defining a fuel passage system open to the surrounding area of the burner tip;
constructing an inner wall and an outer wall;
defining an annulus between the inner wall and the outer wall;
wherein the annulus forms a part of the air passage system; and
constructing heat-conducting structures projecting into the annulus from the outer wall connecting the outer wall and the inner wall;
wherein the heat-conducting structures include connecting ribs; and
defining connecting passages extend through the connecting ribs, open on one end into the annulus and on another end through the outer wall;
wherein each element is constructed using an additive manufacturing process; and
the outer wall, the heat-conducting structures, and the inner wall are produced in one piece.

13. (canceled)
